(19) United States
(12) Patent Application Publication
(10) Pub. No.: US 2018/0364549 A1
(43) Pub. Date: Dec. 20, 2018

(54) CAMERA ACCESSORY AND IMAGING UNIT

(71) Applicant: SONY CORPORATION, TOKYO (JP)

(72) Inventors: MOKUYOH NAKANO, TOKYO (JP); SHUNSUKE IZUMI, TOKYO (JP); TAKAHIRO TSUGE, TOKYO (JP)

(21) Appl. No.: 16/060,324

(22) PCT Filed: Nov. 14, 2016
(86) PCT No.: PCT/JP2016/083720

§ 371 Date: Jun. 7, 2018

(30) Foreign Application Priority Data
Dec. 28, 2015 (JP) 2015-257187

(51) Int. Cl. G03B 17/56; H04N 5/225

(52) U.S. Cl. CPC G03B 17/563; H04N 5/2251; G03B 17/566

(57) ABSTRACT

Functionality corresponding to an imaging situation of an imaging apparatus is improved. The present technology includes an imaging apparatus attachment portion, to/from which an imaging apparatus is attachable/detachable; a control device attachment portion that holds a control apparatus capable of controlling the imaging apparatus; and a grip portion that is coupled to the imaging apparatus attachment portion and the control device attachment portion and is held by fingers. Accordingly, the grip portion can be held by fingers in the state where the imaging apparatus is attached to the imaging apparatus attachment portion and the control apparatus is held by the control device attachment portion. This makes it possible to improve the functionality corresponding to an imaging circumstance of the imaging apparatus.

### TECHNICAL FIELD

The present technology relates to a technical field of a camera accessory attachable to an imaging apparatus and of an imaging unit including the same.

### CITATION LIST

### Patent Literature

Patent Literature 1: Japanese Patent Application Laid-open No. 2012-74945

Patent Literature 2: Japanese Patent Application Laid-open No. 2015-73216

### BACKGROUND ART

Various imaging apparatuses such as a video camera and a still camera are attached to camera accessories and used (see, for example, Patent Literature 1 and Patent Literature 2).

By using such a camera accessory, it is possible to perform, by attaching an imaging apparatus to the camera accessory, imaging under various imaging states such as a high angle and a low angle. By using the camera accessory, the imaging state is diversified, and it is possible to take an image of an object in a desired direction or at a desired angle and enhance the visibility of the object at the time of imaging, which can improve the usability.

The imaging apparatus disclosed in Patent Literature 1 is attached to a frame-shaped camera accessory and used. Since the camera accessory is shaped like a frame, it is easy to hold the camera accessory, and it is possible to secure a stable imaging state.

The imaging apparatus disclosed in Patent Literature 2 is slidable with respect to a camera accessory, and it is possible to change the angle of the imaging apparatus with respect to the camera accessory by sliding the imaging apparatus with respect to the camera accessory. By changing the angle of the imaging apparatus with respect to the camera accessory, it is possible to perform imaging with the imaging apparatus being in a desired orientation, and perform imaging under various imaging states.

### DISCLOSURE OF INVENTION

### Technical Problem

Incidentally, imaging performed by an imaging apparatus is further diversified according to scenes and circumstances such as imaging while moving, imaging in a state of being mounted on a vehicle such as a bicycle, and imaging in a state of being mounted on a human body.

Further, in recent years, there has been an increasing number of examples where transmission/reception of imaging data by wireless communication or the like with an imaging apparatus, imaging control for an imaging apparatus, or the like is performed by a control apparatus such as a remote controller.

Therefore, in a camera accessory to which an imaging apparatus is attached, it is desired to improve the functionality so as to correspond to the above-mentioned diversification of the imaging states and the imaging situation using a control apparatus or the like.

In this regard, a camera accessory and an imaging unit of the present technology are aimed at improving the functionality corresponding to an imaging circumstance of an imaging apparatus.

### Solution to Problem

Firstly, a camera accessory according to the present technology includes: an imaging apparatus attachment portion, to/from which an imaging apparatus is attachable/detachable; a control device attachment portion that holds a control apparatus capable of controlling the imaging apparatus; and a grip portion that is coupled to the imaging apparatus attachment portion and the control device attachment portion and is held by fingers.

Accordingly, the grip portion can be held by fingers in the state where the imaging apparatus is attached to the imaging apparatus attachment portion and the control apparatus is held by the control device attachment portion.

Secondary, in the above-mentioned camera accessory, it is desirable that the grip portion has an annular shape.

Accordingly, an insertion hole in which a finger is to be inserted is formed in the grip portion, and thus the camera accessory can be held in the state where the finger is inserted in the grip portion.

Thirdly, in the above-mentioned camera accessory, it is desirable that the grip portion has an annular shape except for a part of the grip portion.

Accordingly, the insertion hole is formed in a substantially circular shape, and thus the finger can be inserted in the grip portion irrespective of the orientation of the finger.

Fourthly, in the above-mentioned camera accessory, it is desirable that an axial direction of the grip portion is set to a direction orthogonal to an optical axis direction of the imaging apparatus attached to the imaging apparatus attachment portion.

Accordingly, it is possible to insert the finger in the grip portion from the direction orthogonal to the optical axis direction of the imaging apparatus and to thus direct the optical axis of the imaging apparatus to an object side without changing the orientation of the inserted finger.

Fifthly, in the above-mentioned camera accessory, it is desirable that the grip portion includes a recess portion formed on an inner circumferential surface of the grip portion.

Accordingly, a part of the finger is inserted in the recess portion when the finger inserted in the grip portion is set in a predetermined orientation.

Sixthly, in the above-mentioned camera accessory, it is desirable that the grip portion includes a plurality of recess portions formed apart from each other in a circumferential direction.

Accordingly, even when the orientation of the finger inserted in the grip portion is changed by rotation in any direction, a part of the finger is inserted in any of the recess portions at a small rotational angle.

Seventhly, in the above-mentioned camera accessory, it is desirable that a surface including the recess portion is a recess portion forming surface, and the recess portion forming surface has a curved shape that projects toward a central portion of the grip portion.

Accordingly, the inner diameter of the grip portion in the recess portion forming surface is gradually increased toward both the end portions in the axial direction.

Eighthly, in the above-mentioned camera accessory, it is desirable that the grip portion includes a finger placement portion on which a finger is placed in a state where the grip portion is held, and the finger placement portion is formed of a rubber material or a resin material.

Accordingly, the finger is placed on the finger placement portion formed of a rubber material or a resin material, and the finger can be placed on the elastically deformable finger placement portion.

Ninthly, in the above-mentioned camera accessory, it is desirable that the control device attachment portion is rotatable with respect to the imaging apparatus attachment portion.

Accordingly, the orientation of the control apparatus held by the control device attachment portion with respect to the imaging apparatus attached to the imaging apparatus attachment portion is changed by rotation of the control device attachment portion with respect to the imaging apparatus attachment portion.

Tenthly, in the above-mentioned camera accessory, it is desirable that the control device attachment portion is rotatable with respect to the imaging apparatus attachment portion with the grip portion being as a fulcrum.

Accordingly, the grip portion is a portion held by the finger and also functions as a rotation fulcrum of the control device attachment portion with respect to the imaging apparatus attachment portion, and it is unnecessary to separately provide a special rotation fulcrum of the control device attachment portion with respect to the imaging apparatus attachment portion.

Eleventhly, in the above-mentioned camera accessory, it is desirable that a part of the grip portion and the control device attachment portion are integrally formed, and the part of the grip portion and the control device attachment portion are rotatable with respect to the imaging apparatus attachment portion.

Accordingly, the control device attachment portion integrally formed with the grip portion is rotated with respect to the imaging apparatus attachment portion.

Twelfthly, in the above-mentioned camera accessory, it is desirable that the control device attachment portion includes a finger hanging operation portion that is operated when the control device attachment portion is rotated.

Accordingly, by the operation performed on the finger hanging operation portion, the control device attachment portion is rotated with respect to the imaging apparatus attachment portion.

Thirteenthly, in the above-mentioned camera accessory, it is desirable that the control device attachment portion includes an elastic deformation portion that is elastically deformed when the control apparatus is held, and the elastic deformation portion includes an engaging portion that is engaged with the control apparatus.

Accordingly, the engaging portion is engaged with the control apparatus by the deformation of the elastic deformation portion.

Fourteenthly, in the above-mentioned camera accessory, it is desirable that the imaging apparatus attachment portion includes a support projecting portion on which a finger is placed in a state where the grip portion is held.

Accordingly, the grip portion is held in the state where the finger is placed on the support projecting portion, and the control device attachment portion can be rotated in the state where the camera accessory 1 is held with fingers being placed on two different locations.

Fifteenthly, in the above-mentioned camera accessory, it is desirable that a part of an outer surface of the imaging apparatus attachment portion is formed as a planar placed surface.

Accordingly, the camera accessory is placed with the placed surface being in plane contact with the placement surface.

Sixteenthly, in the above-mentioned camera accessory, it is desirable that the imaging apparatus attachment portion includes a first holding portion and a second holding portion that press the imaging apparatus from opposite sides, an outer shape of the second holding portion is larger than an outer shape of the first holding portion, and the second holding portion includes the placed surface.

Accordingly, it is possible to enlarge the placed surface and increase a contact area of the placed surface and the placement surface.

Seventeenthly, it is desirable that the above-mentioned camera accessory further includes a locking lever that locks the imaging apparatus in a state where the imaging apparatus is attached to the imaging apparatus attachment portion.

Accordingly, the imaging apparatus attached to the imaging apparatus attachment portion is locked to the imaging apparatus attachment portion by the locking lever.

Eighteenthly, an imaging unit according to the present technology includes: an imaging apparatus that has an imaging function; a control apparatus that has a communication function and is capable of controlling the imaging apparatus; and a camera accessory including an imaging apparatus attachment portion, to/from which the imaging apparatus is attachable/detachable, a control device attachment portion that holds the control apparatus, and a grip portion that is coupled to the imaging apparatus attachment portion and the control device attachment portion and is held by fingers.

Accordingly, in the camera accessory, the grip portion can be held by fingers in the state where the imaging apparatus is attached to the imaging apparatus attachment portion and the control apparatus is held by the control device attachment portion.

### Advantageous Effects of Invention

According to the present technology, the grip portion can be held by fingers in the state where the imaging apparatus is attached to the imaging apparatus attachment portion and the control apparatus is held by the control device attachment portion. This makes it possible to improve the functionality corresponding to an imaging circumstance of the imaging apparatus.

Note that the effects described herein are merely examples and are not limited, and additional effects may be provided.

### BRIEF DESCRIPTION OF DRAWINGS

FIG. 1 shows an embodiment of a camera accessory and an imaging unit of the present technology together with FIG. 2 to FIG. 21, and is a perspective view of the camera accessory.

FIG. 2 is an exploded perspective view of the camera accessory.

FIG. 3 is a side view of the camera accessory.

FIG. 4 is a plan view of the camera accessory.

FIG. 5 is a bottom view of the camera accessory.

FIG. 6 is a cross-sectional view taken along the line VI-VI in FIG. 3.

FIG. 7 is an enlarged perspective view of a fixed member.

FIG. 8 is an enlarged cross-sectional view of the fixed member.

FIG. 9 is a perspective view of an imaging unit, separately showing an imaging apparatus, a control apparatus, and the camera accessory.

FIG. 10 is a perspective view of the imaging unit.

FIG. 11 is an enlarged side view of the control apparatus.

FIG. 12 is an enlarged bottom view of the control apparatus.

FIG. 13 is a side view showing a state where a control device attachment portion is located at a first rotation position.

FIG. 14 is a side view showing a state where a finger is inserted in a grip portion and the camera accessory is held.

FIG. 15 is a side view showing a state where the control device attachment portion is located at a second rotation position.

FIG. 16 is a side view showing a state where a finger is placed on a support projecting portion.

FIG. 17 is an enlarged side view conceptually showing a state where a finger is inserted in the grip portion.

FIG. 18 is an enlarged side view conceptually showing a state where the finger inserted in the grip portion is rotated and a part of the finger is inserted in a recess portion.

FIG. 19 is a side view showing an example of a camera accessory in which the control device attachment portion is rotated with respect to the grip portion.

FIG. 20 is a side view showing an example of a camera accessory in which the whole of the control device attachment portion and the grip portion is rotated with respect to the imaging apparatus attachment portion.

FIG. 21 is a side view showing an example of a camera accessory including a frame portion.

### MODE(S) FOR CARRYING OUT THE INVENTION

Hereinafter, a mode for carrying out the present technology will be described with reference to the attached drawings.

In the following embodiment, a camera accessory of the present technology is applied to a camera accessory capable of attaching a video camera as an imaging apparatus. Note that an application range of the camera accessory of the present technology is not limited to a video camera as an imaging apparatus to be attached, and the camera accessory of the present technology can also be applied to a camera accessory capable of attaching another imaging apparatus such as a still camera. Further, an imaging unit of the present technology can also be widely applied to an imaging unit including another imaging apparatus such as a still camera without being limited to the video camera.

In the following description, front-back, vertical, and lateral directions will be indicated by directions viewed from a photographer. Therefore, the object side is forward, and the photographer side is rearward.

Note that the front-back, vertical, and lateral directions described below are for convenience of the description, and the directions are not limited to these directions regarding implementation of the present technology.

<Configuration of Camera Accessory>

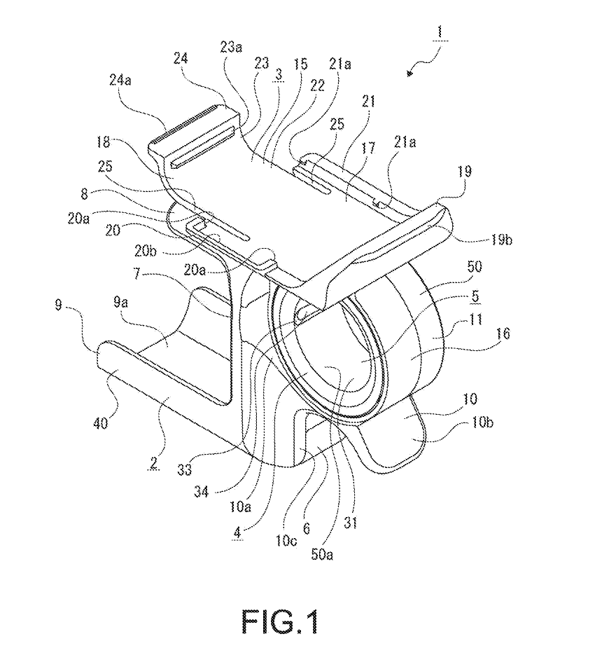

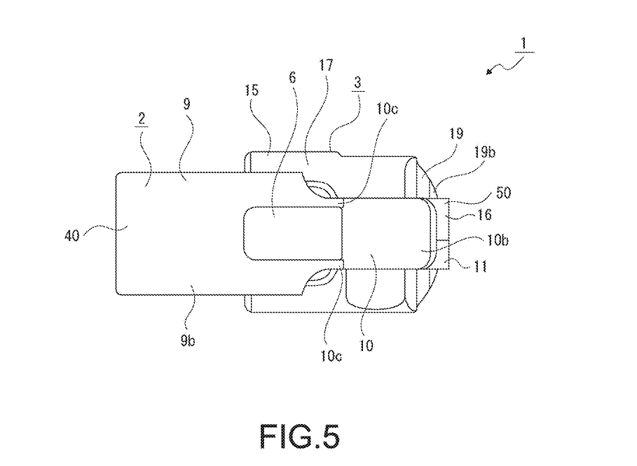

A camera accessory 1 includes a base member 2, a movable member 3, a rotation member 4, a fixed member 5, and a locking lever 6 (see FIG. 1 to FIG. 6).

The base member 2 includes a substantially flat plate-like coupling surface portion 7 oriented in the front-back direction, a first holding portion 8 that projects forward from the upper end portion of the coupling surface portion 7, a second holding portion 9 that projects forward from the lower end portion of the coupling surface portion 7, a projecting portion 10 that projects substantially rearward from the coupling surface portion 7, and a supporting portion 11 that is continuously provided on the upper side of the projecting portion 10.

The coupling surface portion 7 is formed to have a vertically long shape, and the upper edge portion thereof is formed to have a semicircular arc shape that projects upward.

The first holding portion 8 is formed to have a gentle circular arc shape that projects upward with the central portion in the lateral direction thereof located uppermost. In the first holding portion 8, a facing hole 8a is formed.

The second holding portion 9 is located to face the first holding portion 8 and larger in size in the front-back direction than the first holding portion 8, and the front end thereof is located forward relative to the front end of the first holding portion 8. Therefore, the outer shape of the second holding portion 9 is larger than that of the first holding portion 8.

The upper surface of the second holding portion 9 is formed as a gentle circular arc surface 9a that projects downward with the central portion in the lateral direction thereof located lowermost. The lower surface of the second holding portion 9 is formed as a placed surface 9b formed in a plane shape.

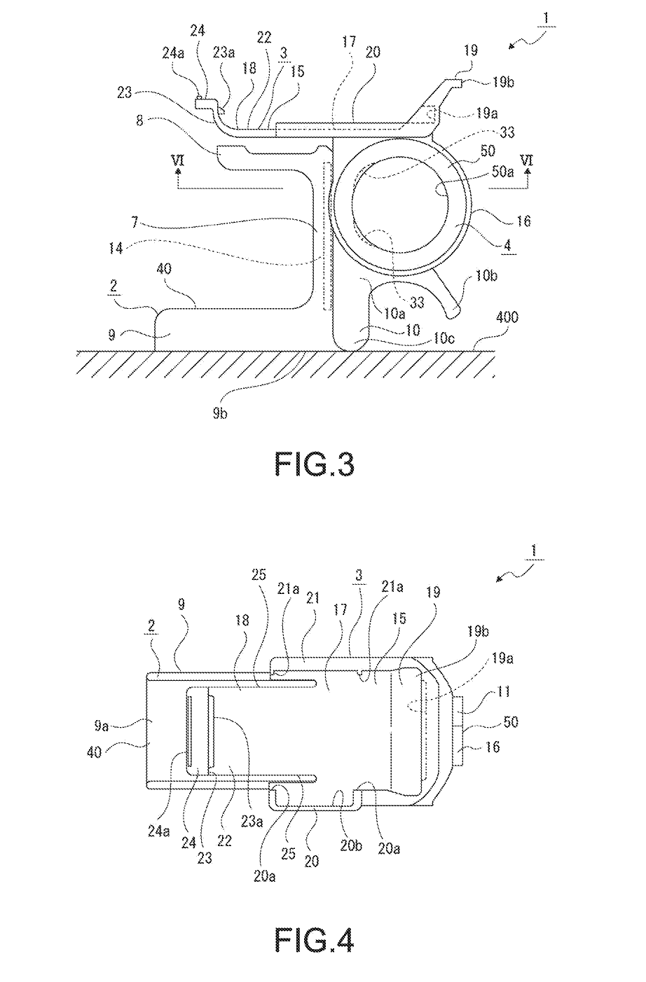

The camera accessory 1 is placed on a placement surface 400 of a desk, a table, or the like (see FIG. 3) in some cases, and is often placed with the second holding portion 9 being in contact with the placement surface 400. Therefore, as described above, since the placed surface 9b is formed in a plane shape, the camera accessory 1 is placed with the placed surface 9b being in plane contact with the placement surface 400, and thus the camera accessory 1 can be stably placed.

Further, the outer shape of the second holding portion 9 is larger than that of the first holding portion 8, and the placed surface 9b is formed in the second holding portion 9. This makes it possible to enlarge the placed surface 9b and increase a contact area of the placed surface 9b and the placement surface 400, and the camera accessory 1 can be more stably placed on the placement surface 400.

The projecting portion 10 includes a support portion 10a that projects obliquely rearward and downward from a portion close to the upper end of the coupling surface portion 7, a support projecting portion 10b that projects obliquely rearward and downward from the rear end of the support portion 10a, and leg portions 10c, 10c that project downward from the right and left end portions of the support portion 10a. The front ends of the leg portions 10c, 10c are continuous to the right and left end portions of the coupling surface portion 7.

In the base member 2, a supporting hole 2a is formed at a portion extending from the projecting portion 10 to the coupling surface portion 7. The supporting hole 2a penetrates in the front-back direction, and is opened downward.

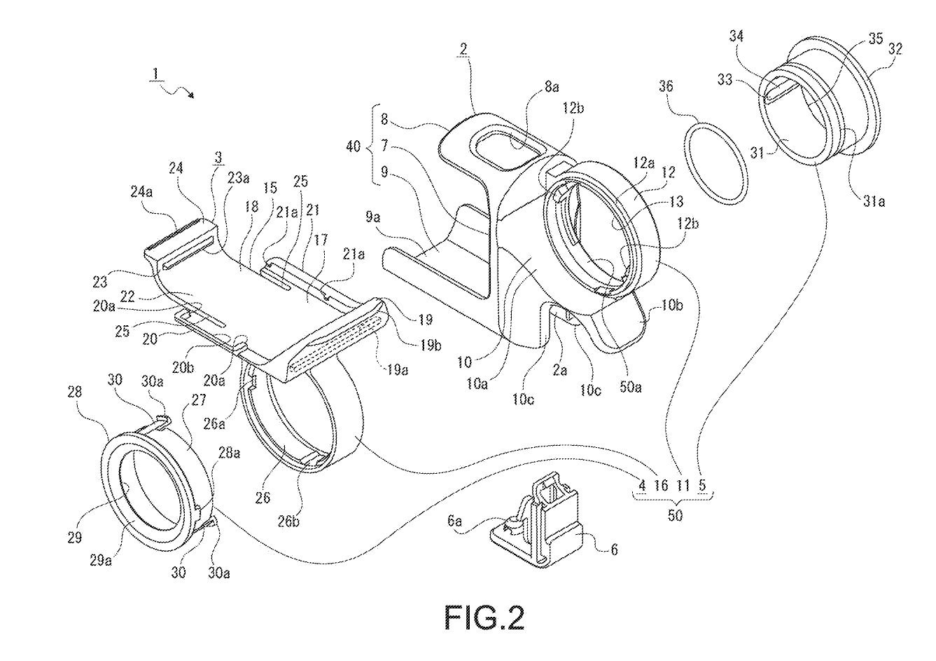

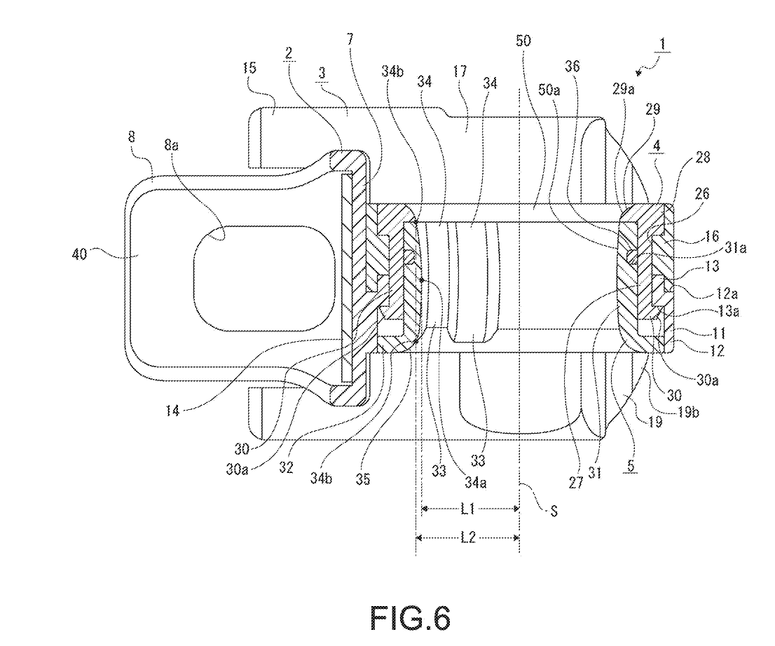

The supporting portion 11 is formed to have a substantially annular shape penetrating in the lateral direction, and continuously provided at a portion extending from the substantially upper half portion of the coupling surface portion 7 to the support portion 10a of the projecting portion 10. The supporting portion 11 includes an outer annular surface portion 12 and an inner annular surface portion 13, and the inner annular surface portion 13 projects leftward from the left end portion of the outer annular surface portion 12 (see FIG. 2 and FIG. 6).

The inner annular surface portion 13 is located on the inner peripheral side of the outer annular surface portion 12, and the left side surface of the outer annular surface portion 12 and the right side surface of the inner annular surface portion 13 are formed as stepped surfaces. These stepped surfaces are an outer stepped surface 12a and an inner stepped surface 13a.

In the outer annular surface portion 12, stopper projecting portions 12b, 12b that project inward are provided apart from each other in the circumferential direction. The stopper projecting portions 12b, 12b are provided at positions continuous to the outer stepped surface 12a and the inner annular surface portion 13.

To the front surface of the coupling surface portion 7 in the base member 2, a cushion 14 is affixed (see FIG. 6).

The movable member 3 is formed by integrally forming a control device attachment portion 15 and a ring portion 16 (see FIG. 1 to FIG. 6).

The control device attachment portion 15 includes a flat plate-like receiving surface portion 17 that is directed in the substantially vertical direction, an elastic deformation portion 18 continuous to the front end of the receiving surface portion 17, and a retaining projecting portion 19 continuous to the rear end of the receiving surface portion 17.

The left and right end portions of the receiving surface portion 17 are provided as receiving projecting portions 20 and 21 that project upward relative to other parts. The receiving projecting portion 20 on the left side is formed to have a shape in which the front and rear end portions thereof project rightward from other parts, and the right end portions are provided as supporting projections 20a, 20a. The space on the right side of the receiving projecting portion 20 is formed as a placement recessed portion 20b opened rightward and upward. On the left side portion of the receiving projecting portion 21 on the right side, supporting projections 21a, 21a are provided apart from each other in the front-back direction.

The elastic deformation portion 18 is continuous to a part excluding the right and left end portions of the receiving surface portion 17, and includes a flat plate-like connecting portion 22 directed in the vertical direction, a holding projecting portion 23 bent so as to project upward from the front end portion of the connecting portion 22, and a horizontally long to-be-operated portion 24 that projects forward from the upper end portion of the holding projecting portion 23.

Between the connecting portion 22 and the front end portions of the receiving projecting portions 20 and 21, slits 25, 25 opened forward are formed. Therefore, the elastic deformation portion 18 is elastically deformable in the direction in which the front end portion thereof is displaced in the vertical direction with respect to the receiving surface portion 17.

On the rear surface of the holding projecting portion 23, an engaging portion 23a that projects rearward and extends in the lateral direction is provided.

In the front end portion of the upper surface of the to-be-operated portion 24, an anti-slip portion 24a that projects upward and extends in the lateral direction is provided. The to-be-operated portion 24 is a portion to be pressed downward to elastically deform the elastic deformation portion 18. Since the to-be-operated portion 24 includes the anti-slip portion 24a, a finger is placed on the anti-slip portion 24a when the to-be-operated portion 24 is pressed downward, and a downward press operation on the to-be-operated portion 24 can be easily and reliably performed.

On the front surface of the retaining projecting portion 19, an insertion groove 19a that extends in the lateral direction is formed. The upper end portion of the retaining projecting portion 19 is provided as a finger hanging operation portion 19b. A part of the finger hanging operation portion 19b projects rearward. The finger hanging operation portion 19b has a function of being operated when a finger is placed thereon, and the movable member 3 is rotated with respect to the base member 2 by operating the finger hanging operation portion 19b.

The ring portion 16 is formed to have a substantially annular shape penetrating in the lateral direction, and the upper end portion thereof is continuous to the lower end portion of the receiving surface portion 17. A portion of the ring portion 16 excluding the right and left end portions is provided as a protruding portion 26 that protrudes inward (see FIG. 2 and FIG. 6).

In the protruding portion 26, positioning recessed portions 26a, 26a opened leftward and inward are formed apart from each other in the circumferential direction. In the protruding portion 26, recessed portion for insertion 26b, 26b opened in the lateral direction and inward are formed apart from each other in the circumferential direction.

The ring portion 16 is coupled to the supporting portion 11 from the left side, and thus, the movable member 3 is rotatably supported by the base member 2. In a state where the movable member 3 is supported by the base member 2, the right end surface of the ring portion 16 is located so as to face the outer stepped surface 12a formed in the outer annular surface portion 12 of the supporting portion 11, and the right end surface of the protruding portion 26 is located so as to face the left end surface of the inner annular surface portion 13 in the supporting portion 11.

The rotation member 4 includes an annular portion 27 formed to have a substantially annular shape penetrating in the lateral direction, an outer flange portion 28 that expands outward from the left end portion of the annular portion 27, an inner flange portion 29 that expands inward from the left end portion of the annular portion 27, and sliding engaging portions 30, 30 that project rightward from the annular portion 27.

In the outer flange portion 28, positioning projecting portions 28a, 28a that project rightward are provided apart from each other in the circumferential direction.

The inner circumferential surface of the inner flange portion 29 is formed as a guide surface 29a. The guide surface 29a is formed in a curved shape that is displaced toward the outer circumference side as it goes leftward. A finger may be inserted in the fixed member 5 through the rotation member 4 from the left side. However, the guide surface 29a is formed in the rotation member 4, and thus insertion of the finger in the rotation member 4 and the fixed member 5 and pulling-out of the finger from the rotation member 4 and the fixed member 5 can be easily performed.

The sliding engaging portions 30, 30 are provided apart from each other in the circumferential direction and include at the tip portions thereof engaging claws 30a, 30a that project outward.

The rotation member 4 is coupled to the ring portion 16 of the movable member 3 from the left side. The positioning projecting portions 28a, 28a are inserted and positioned in the positioning recessed portions 26a, 26a formed in the protruding portion 26, the sliding engaging portions 30, 30 are inserted through the recessed portion for insertion 26b, 26b formed in the protruding portion 26 and project rightward from the ring portion 16, and thus, the coupling of the rotation member 4 to the ring portion 16 is performed. At this time, the sliding engaging portions 30, 30 that project from the ring portion 16 to the right side are elastically deformed by the engaging claws 30a, 30a being in sliding contact with the inner annular surface portion 13 of the base member 2, and elastically restored when they pass over the inner annular surface portion 13, and thus, the engaging claws 30a, 30a are engaged with the inner stepped surface 13a. In the rotation member 4, the right side surface of the outer flange portion 28 is located so as to face the left side surface of the protruding portion 26, and the outer flange portion 28 of the rotation member 4 and the inner annular surface portion 13 of the base member 2 are located on the left and right sides of the protruding portion 26.

As described above, the outer flange portion 28 of the rotation member 4 and the inner annular surface portion 13 of the base member 2 are located on the left and right sides of the protruding portion 26 in the ring portion 16, the engaging claws 30a, 30a are engaged with the inner stepped surface 13a, and thus, the ring portion 16 and the rotation member 4 are prevented from falling off from the supporting portion 11. Since the positioning projecting portions 28a, 28a are inserted in the positioning recessed portion 26a, 26a, the rotation member 4 is rotated around the ring portion 16 as a fulcrum integrally with the movable member 3 with respect to the base member 2.

The movable member 3 and the rotation member 4 are rotatable with respect to the base member 2 within the range that the engaging claws 30a, 30a are in contact with the stopper projecting portions 12b, 12b provided in the supporting portion 11.

The fixed member 5 is formed of a rubber material or a resin material to have a substantially annular shape penetrating in the lateral direction, and includes a finger placement portion 31 and a flange portion 32 that expands outward from the right end portion of the finger placement portion 31 (see FIG. 2). Since the fixed member 5 is formed of a rubber material or a resin material, the fixed member 5 is elastically deformable.

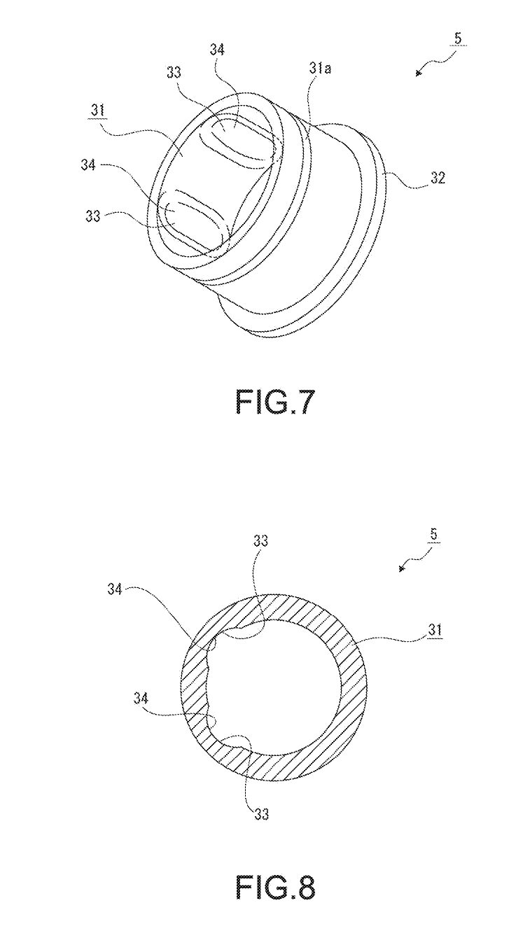

On the outer surface side of the finger placement portion 31, a mounting groove 31a that extends in the circumferential direction is formed. On the inner surface of the finger placement portion 31, recess portions 33, 33 are formed apart from each other in the circumferential direction (see FIG. 6 to FIG. 8). A recess portion forming surface 34 that is a surface forming the recess portion 33 in the finger placement portion 31 is formed in a gentle curve shape, and the recess portion 33 is formed in a shallow recess shape (see FIG. 8). As shown in FIG. 6, the recess portion forming surface 34 is formed in a curved shape that projects toward the central axis S of the fixed member 5 and is formed such that a distance L1 between the center 34a in the axial direction (lateral direction) of the fixed member 5 and the central axis S is the smallest, and that distances L2, L2 between both end portions 34b, 34b in the axial direction of the fixed member 5 and the central axis S are the largest.

The inner circumferential surface at the boundary portion between the finger placement portion 31 and the flange portion 32 is formed as a guide surface 35. The guide surface 35 is formed in a curved shape that is displaced toward the outer circumference side as it goes toward the flange portion 32 from the finger placement portion 31. The guide surface 35 is formed in the fixed member 5, and thus insertion of the finger in the fixed member 5 and pulling-out of the finger from the fixed member 5 can be easily performed.

An O-ring 36 is inserted in and mounted on the mounting groove 31a of the finger placement portion 31. The O-ring 36 is formed of, for example, a rubber material.

The fixed member 5 is inserted in the supporting portion 11 of the base member 2 from the right side, and fixed to the supporting portion 11 by press fitting, bonding, or the like. In the state where the fixed member 5 is fixed to the supporting portion 11, the flange portion 32 is located on the inner peripheral side of the right end portion of the outer annular surface portion 12, the left half portion of the finger placement portion 31 is located on the inner peripheral side of the annular portion 27 in the rotation member 4, and the left end surface of the finger placement portion 31 is located so as to face the right side surface of the inner flange portion 29 in the rotation member 4. At this time, the O-ring 36 is pressed against the inner peripheral surface of the annular portion 27 from the inside, and friction occurs between the annular portion 27 and the O-ring 36.

In the state where the fixed member 5 is fixed to the supporting portion 11, the recess portions 33, 33 of the finger placement portion 31 are located in the range of the front half, and there are no recess portions 33, 33 in the range of the rear half.

The locking lever 6 is inserted in the supporting hole 2a formed in the base member 2 from below, and supported by the base member 2 so as to be movable in the vertical direction. In the front end portion of the locking lever 6, a fitting projecting portion 6a that projects upward is provided.

In the camera accessory 1 configured as described above, as shown in FIG. 1 and FIG. 2, the coupling surface portion 7, the first holding portion 8, and the second holding portion 9 of the base member 2 function as an imaging apparatus attachment portion 40 to/from which the imaging apparatus 100 is attachable/detachable, and the control device attachment portion 15 of the movable member 3 has a function of holding a control apparatus 200. Further, the supporting portion 11 of the base member 2, the ring portion 16 of the movable member 3, the rotation member 4, and the fixed member 5 function as a grip portion 50 to be held by a finger. The grip portion 50 is formed to have an annular shape, and the internal space of the grip portion 50 is formed as an insertion hole 50a in which a finger is to be inserted.

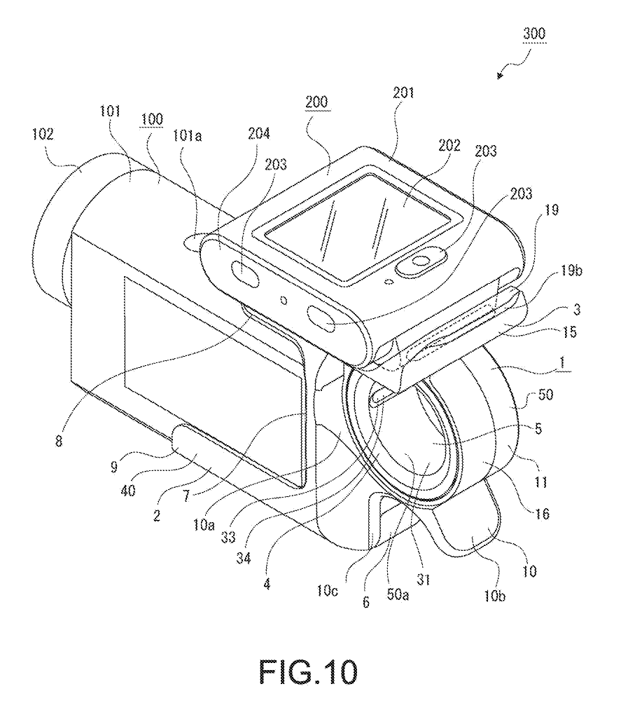

Further, in the camera accessory 1, by attaching the imaging apparatus 100 to the imaging apparatus attachment portion 40 and holding the control apparatus 200 by the control device attachment portion 15, the camera accessory 1, the imaging apparatus 100, and the control apparatus 200 constitute an imaging unit 300 (see FIG. 10).

<Configuration, etc. of Imaging Apparatus>

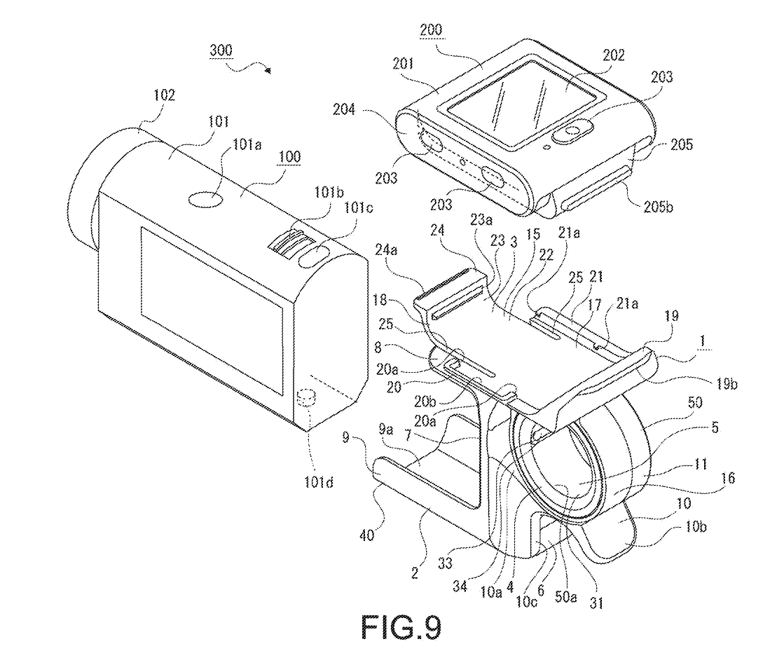

Hereinafter, description will be given on a schematic configuration of the imaging apparatus 100 and the attachment/detachment thereof with respect to the camera accessory 1 (see FIG. 9 to FIG. 10).

As described above, the imaging apparatus 100 is attachable to the imaging apparatus attachment portion 40. The imaging apparatus 100 is, for example, a video camera, and the length thereof in the front-back direction is longer than those in the vertical and lateral directions. The imaging apparatus 100 includes a camera main body 101 and an imaging unit 102 that projects forward from an upper part of the front surface of the camera main body 101. The camera main body 101 is formed to have a vertical cross section of, for example, a vertically long oval shape.

On the upper surface of the camera main body 101, a power source button 101a, a switching knob 101b, and a lighting unit 101c are disposed in sequence from the front side. The switching knob 101b is, for example, an operation unit that switches between availability and unavailability of wireless communication with the control apparatus 200. The lighting unit 101c is lighted when the power source button 101a is pressed and powered on, to thus recognize that the camera accessory 1 is driven.

A fitting hole 101d opened downward is formed in a rear end portion of the camera main body 101. The fitting hole 101d is, for example, a positioning hole in which a positioning pin provided to a tripod is inserted when being mounted to the tripod.

The rear end portion of the camera main body 101 is inserted between the first holding portion 8 and the second holding portion 9 in the camera accessory 1 from the front side, the imaging apparatus 100 is supported by the first holding portion 8 and the second holding portion 9 from above and below, and thus, the imaging apparatus 100 is attached to the imaging apparatus attachment portion 40 (see FIG. 10). In the state where the imaging apparatus 100 is held by the imaging apparatus attachment portion 40, the rear surface of the camera main body 101 is pressed against the cushion 14 affixed to the front surface of the coupling surface portion 7, which suppresses scratching of the camera main body 101 and rattling of the imaging apparatus 100 with respect to the imaging apparatus attachment portion 40.

In the state where the imaging apparatus 100 is attached to the imaging apparatus attachment portion 40, the power source button 101a of the imaging apparatus 100 is located in front of the first holding portion 8, and the switching knob 101b and the lighting unit 101c are located at the facing hole 8a formed in the first holding portion 8. Therefore, in the state where the imaging apparatus 100 is attached to the imaging apparatus attachment portion 40, a user is capable of operating the power source button 101a, and also operating the switching knob 101b and viewing the state of the lighting unit 101c via the facing hole 8a.

When the locking lever 6 that has been moved downward is operated and moved upward in the state where the imaging apparatus 100 is attached to the imaging apparatus attachment portion 40, the fitting projecting portion 6a of the locking lever 6 is fit into the fitting hole 101d formed in the camera main body 101, and the imaging apparatus 100 is locked in the imaging apparatus attachment portion 40. On the contrary, when the locking lever 6 is operated and moved downward in the state where the imaging apparatus 100 is attached to the imaging apparatus attachment portion 40, the fitting projecting portion 6a of the locking lever 6 is pulled out from the fitting hole 101d formed in the camera main body 101, and the imaging apparatus 100 can be detached from the camera accessory 1 by pulling the imaging apparatus 100 forward from the imaging apparatus attachment portion 40.

In such a manner, since the imaging apparatus attachment portion 40 includes the locking lever 6 that locks the imaging apparatus 100 in the state where the imaging apparatus 100 is attached, the imaging apparatus 100 attached to the imaging apparatus attachment portion 40 is locked to the imaging apparatus attachment portion 40 by the locking lever 6, and thus, the imaging apparatus 100 can be prevented from falling off from the imaging apparatus attachment portion 40.

<Configuration, etc. of Control Apparatus>

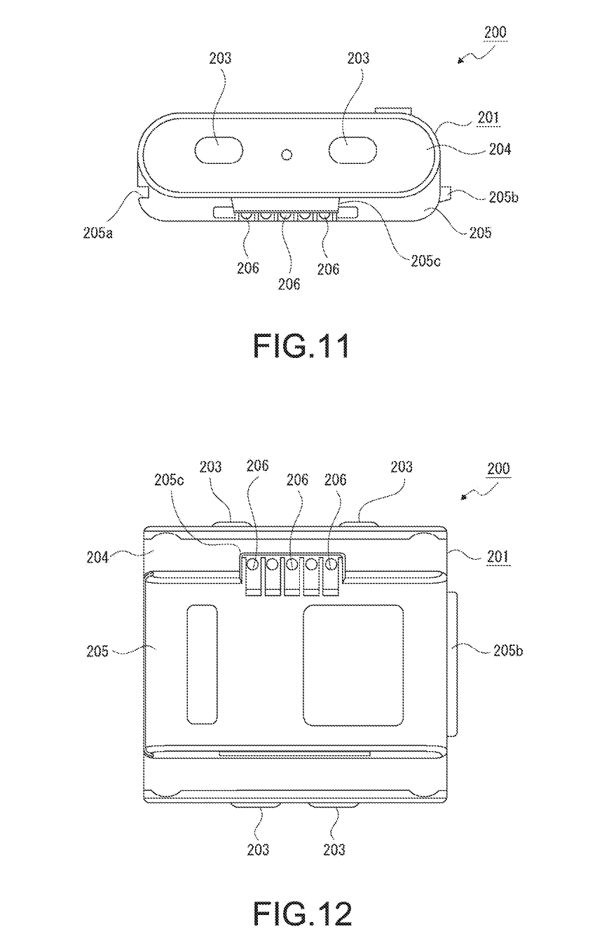

Hereinafter, description will be given on a schematic configuration of the control apparatus 200 and the attachment/detachment thereof with respect to the camera accessory 1 (see FIG. 9 to FIG. 12).

As described above, the control apparatus 200 is held by the control device attachment portion 15. The control apparatus 200 is, for example, a remote control apparatus and has a function of performing various types of control on the imaging apparatus 100. By using the control apparatus 200, for example, it is possible to display an image or video taken by the imaging apparatus 100, or set or change various imaging modes or imaging states for the imaging apparatus 100.

Note that the control apparatus 200 may be capable of performing, for example, control on a portable information terminal, a computer, or the like, or transmission/reception of data with these devices, in addition to control on the imaging apparatus 100.

The transmission/reception of signals in the control apparatus 200 may be performed by any of communication means such as wired communication and wireless communication including a wireless LAN (Local Area Network) or near field communication.

The control apparatus 200 includes, for example, a casing 201, a display unit 202, operation units 203, 203, . . . .

The casing 201 includes a main body portion 204 formed to have a flat substantially rectangular shape, and a to-be-held projecting portion 205 that protrudes downward from a part of the main body portion 204 excluding right and left end portions thereof. At the front end portion of the to-be-held projecting portion 205, an engaging recessed portion 205a that is opened forward and extends laterally is formed. At the rear end portion of the to-be-held projecting portion 205, an insertion projecting portion 205b that projects rearward and extends laterally is provided. At the central portion of the to-be-held projecting portion 205 in the front-back direction, a projecting portion for terminal 205c that projects leftward is provided.

In the to-be-held projecting portion 205, connection terminals 206, 206, . . . are provided to be arranged in the front-back direction on the projecting portion for terminal 205c. The connection terminals 206, 206, . . . are located above a lower surface of the to-be-held projecting portion 205.

The display unit 202 is disposed on an upper surface of the main body portion 204. On the display unit 202, various types of information such as a driving state of the imaging apparatus 100 and a set mode, as well as an image or video taken by the imaging apparatus 100 can be displayed.

The operation buttons 203, 203, . . . are disposed on, for example, the upper surface or the left and right side surfaces of the main body portion 204. As the operation buttons 203, 203, . . . , for example, an imaging button, a power source button, a zoom button, and a mode setting button are provided.

The control apparatus 200 is inserted from above in a state of being inclined with the front thereof being lifted between the holding projecting portion 23 and the mounting projecting portion 19 in the camera accessory 1, and the insertion projecting portion 205b is inserted in the insertion groove 19a. In the state where the insertion projecting portion 205b is inserted in the insertion groove 19a, when the front end portion is pressed downward, the front surface of the to-be-held projecting portion 205 comes into sliding contact with the engaging portion 23a of the holding projecting portion 23, and the elastic deformation portion 18 is elastically deformed in the direction in which the holding projecting portion 23 and the to-be-operated portion 24 are displaced downward. When the engaging recessed portion 205a corresponds to the engaging portion 23a in the state where the elastic deformation portion 18 is elastically deformed, the elastic deformation portion 18 is elastically restored, the engaging portion 23a is inserted in and engaged with the engaging recessed portion 205a, and thus, and the control apparatus 200 is held by the control device attachment portion 15.

In the state where the control apparatus 200 is held by the control device attachment portion 15, the supporting projections 20a, 20a of the receiving projecting portion 20 and the supporting projections 21a, 21a of the receiving projecting portion 21 are brought into contact with the casing 201. Therefore, since the casing 201 is supported by the supporting projections 20a, 20a, 21a, and 21a in a state of being point-contacted at four points, rattling of the control apparatus 200 with respect to the control device attachment portion 15 is prevented, and the control apparatus 200 is held in a stable state by the control device attachment portion 15.

Further, at this time, the projecting portion for terminal 205c of the to-be-held projecting portion 205 is inserted in the placement recessed portion 20b formed by the receiving projecting portion 20. Therefore, since any part of the control device attachment portion 15 does not come into contact with the connection terminals 206, 206, . . . , it is possible to prevent the connection terminals 206, 206, . . . from being scratched or damaged.

When a pressing operation is performed on the to-be-operated portion 24 downward in the state where the control apparatus 200 is held by the control device attachment portion 15, the elastic deformation portion 18 is elastically deformed in the direction in which the holding projecting portion 23 and the to-be-operated portion 24 are displaced downward, and the engagement of the engaging portion 23a with the engaging recessed portion 205a is released. Therefore, by pulling out the insertion projecting portion 205b from the insertion groove 19a and lifting the control apparatus 200 upward from the control device attachment portion 15, it is possible to detach the control apparatus 200 from the camera accessory 1.

As described above, the elastic deformation portion 18 that is to be elastically deformed when the control apparatus 200 is held is provided in the control device attachment portion 15 of the camera accessory 1, and the engaging portion 23a that is to be engaged with the control apparatus 200 is provided in the elastic deformation portion 18.

Therefore, since the engaging portion 23a is engaged with the control apparatus 200 by the deformation of the elastic deformation portion 18, it is possible to easily mount the control apparatus 200 on the control device attachment portion 15 with a simple structure.

<Usage Mode of Camera Accessory>

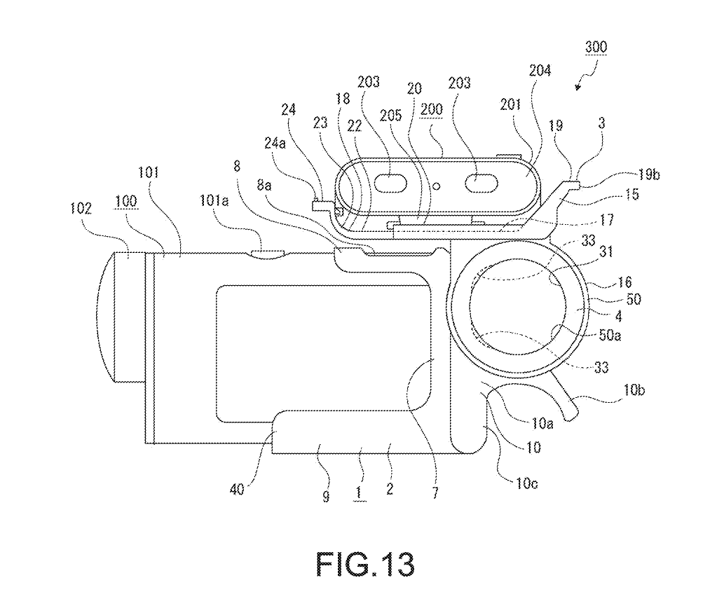

Hereinafter, description will be given on a usage mode of the camera accessory 1 in the state where the imaging apparatus 100 is attached to the imaging apparatus attachment portion 40, and the control apparatus 200 is held by the control device attachment portion 15 (see FIG. 13 to FIG. 18).

Before using the camera accessory 1, for example, the receiving surface portion 17 of the control device attachment portion 15 is in a horizontal state by the weight of the control apparatus 200, the control device attachment portion 15 is located at a first rotation position, and the control apparatus 200 is located closest to the imaging apparatus 100 (see FIG. 13). At this time, the engaging claw 30a of one sliding engaging portion 30 in the rotation member 4 is brought into contact with one stopper projecting portion 12b of the supporting portion 11 in the base member 2, which regulates rotation of the control device attachment portion 15 in the direction of being inclined to the front side.

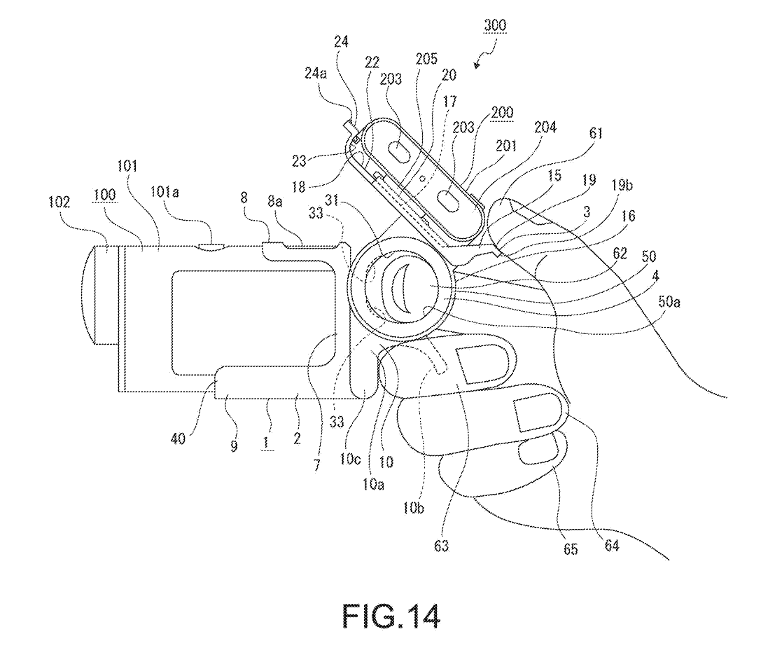

A user inserts, for example, an index finger 62 in the grip portion 50, places a middle finger 63 on the support projecting portion 10b of the projecting portion 10 from below, and holds the camera accessory 1 by the index finger 62 and the middle finger 63 (see FIG. 14). The index finger 62 is placed on a portion where the recess portions 33, 33 are not formed on the inner circumferential surface of the finger placement portion 31 in the fixed member 5. At this time, with the index finger 62 being inserted in the grip portion 50, a ring finger 64 or a pinky finger 65 may be placed on the support projecting portion 10b from below so as to hold the camera accessory 1 by the index finger 62 and the ring finger 64 or by the index finger 62 and the pinky finger 65.

Note that the middle finger 63 or the ring finger 64 may be inserted in the grip portion 50, the ring finger 64 or the pinky finger 65 may be placed on the support projecting portion 10b from below, and the camera accessory 1 may be held by the middle finger 63 and the ring finger 64, by the index finger 62 and the pinky finger 65, or by the ring finger 64 and the pinky finger 65.

Since the grip portion 50 is formed to have an annular shape in the camera accessory 1 as described above, the insertion hole 50a in which a finger is to be inserted is formed in the grip portion 50, and it is possible to hold the camera accessory 1 in the state where the finger is inserted in the grip portion 50. Therefore, it is possible to secure favorable holding property with respect to the camera accessory 1, and prevent the camera accessory 1 from falling off.

Further, since a portion excluding the recess portions 33, 33 in the grip portion 50 is formed to have an annular shape, the insertion hole 50a is formed in a substantially circular shape, and thus the finger can be inserted in the grip portion 50 irrespective of the orientation of the finger, and the usability of the camera accessory 1 can be improved.

Furthermore, an axial direction (lateral direction) of the grip portion 50 is set to a direction orthogonal to an optical axis direction (front-back direction) of the imaging apparatus 100 to be attached to the imaging apparatus attachment portion 40.

Therefore, it is possible to insert the finger in the grip portion 50 from the direction orthogonal to the optical axis direction of the imaging apparatus 100 and to thus direct the optical axis of the imaging apparatus 100 to the object side without changing the orientation of the inserted finger, to thus improve the usability of the camera accessory 1 and shorten a time period before imaging by the imaging apparatus 100.

Furthermore, the grip portion 50 includes the finger placement portion 31 on which the finger is to be placed in the state where the camera accessory 1 is held. The finger placement portion 31 is formed of a rubber material or a resin material.

Therefore, since the finger is placed on the finger placement portion 31 formed of a rubber material or a resin material, the finger can be placed on the elastically deformable finger placement portion 31, the finger placement portion 31 comes into contact with the finger along with the surface of the finger, and stability of the holding state with respect to the grip portion 50 and improvement in holding property can be achieved.

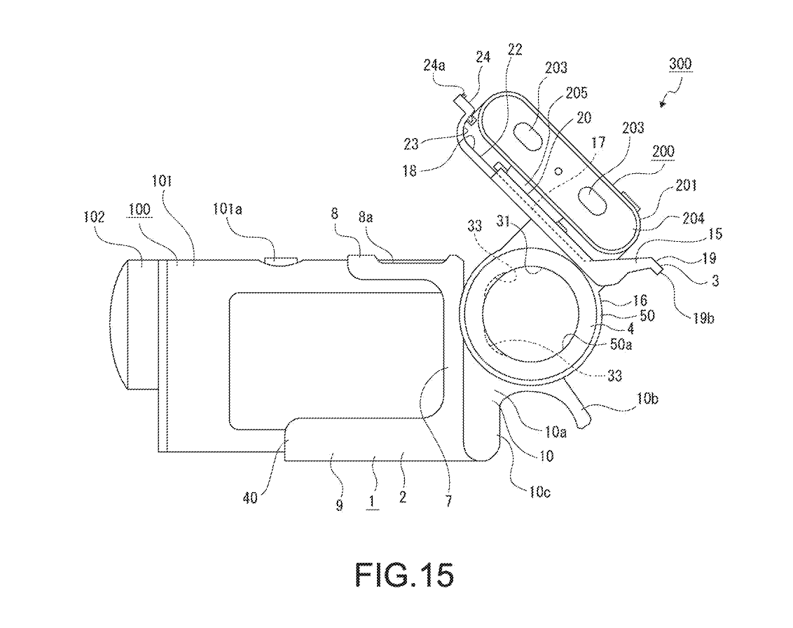

As described above, for example, in the state where the camera accessory 1 is held by the index finger 62 and the middle finger 63, by placing a thumb 61 on the finger hanging operation portion 19b of the control device attachment portion 15 from above and pressing the finger hanging operation portion 19b downward, the control device attachment portion 15 can be rotated with respect to the imaging apparatus attachment portion 40. The rotation of the control device attachment portion 15 can be performed to a second rotation position at which the engaging claw 30a of the other sliding engaging portion 30 in the rotation member 4 is brought into contact with the other stopper projecting portion 12b of the supporting portion 11 in the base member 2, which regulates the rotation (see FIG. 15).

In such a manner, since the control device attachment portion 15 includes the finger hanging operation portion 19b to be operated in the rotation, by the operation performed on the finger hanging operation portion 19b, the control device attachment portion 15 is rotated with respect to the imaging apparatus attachment portion 40, and the control device attachment portion 15 can be easily rotated by a simple operation.

Further, since the finger is placed on the support projecting portion 10b when the control device attachment portion 15 is rotated, the grip portion 50 is held in the state where the finger is placed on the support projecting portion 10b, the control device attachment portion 15 can be rotated in the state where the camera accessory 1 is held with fingers being placed on two different locations, and the control device attachment portion 15 can be rotated in a stable holding state.

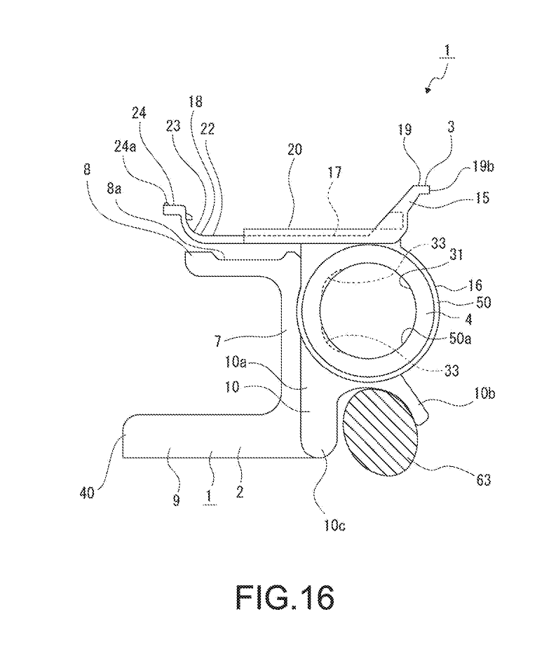

Note that since the support projecting portion 10b projects obliquely rearward and downward from the rear end of the support portion 10a as described above, with the index finger 62 being inserted in the grip portion 50 and with the middle finger 63 being placed on the support projecting portion 10b, a ball 63a of the middle finger 63 comes into contact with the support projecting portion 10b in a large contact area and in a comfortable orientation (see FIG. 16). Therefore, the camera accessory 1 can be held in the state where the middle finger 63 is brought into contact with the support projecting portion 10b naturally without providing a feeling of strangeness, and improvement in holding property with respect to the camera accessory 1 can be achieved.

As described above, the state where the control device attachment portion 15 is rotated with respect to the imaging apparatus attachment portion 40 by the operation performed on the finger hanging operation portion 19b has been described, but the user can rotate the control device attachment portion 15 with respect to the imaging apparatus attachment portion 40 by imparting force to the control apparatus 200 in a necessary direction with the thumb 61 being placed on the control apparatus 200.

When the control device attachment portion 15 is rotated, the movable member 3 and the rotation member 4 are integrally rotated with respect to the base member 2 in the state where the annular portion 27 of the rotation member 4 is in sliding contact with the O-ring 36. Therefore, the control device attachment portion 15 can be held at an arbitrary position in the midstream of the rotation by friction that occurs between the annular portion 27 and the O-ring 36, and the user can rotate the control device attachment portion 15 to a necessary rotational angle, and hold the control apparatus 200 in a desired inclined state.

Further, while the rotation member 4 is integrally rotated when the control device attachment portion 15 is rotated, a rotation operation is performed with a finger of the user being placed on the inner circumferential surface of the fixed member 5, and thus the rotation member 4 to be rotated hardly slides on the finger of the user, and a smooth rotation operation that does not provide a feeling of strangeness to the user is performed.

In the state where the control device attachment portion 15 is rotated and the control apparatus 200 is held at a desired inclination as described above, the user can visually recognize an image, a video, or the like displayed on the display unit 202 of the control apparatus 200 and also perform an operation for the operation units 203, 203, . . . .

Meanwhile, when the control device attachment portion 15 is rotated from the second rotation position toward the first rotation position, the user can rotate the control device attachment portion 15 with respect to the imaging apparatus attachment portion 40 by, for example, placing the finger on the finger hanging operation portion 19b from below and pressing the finger hanging operation portion 19b upward. Since the finger hanging operation portion 19b is formed in a shape that partially projects rearward, when the finger hanging operation portion 19b is pushed up from below and operated, the operation can be easily and reliably performed.

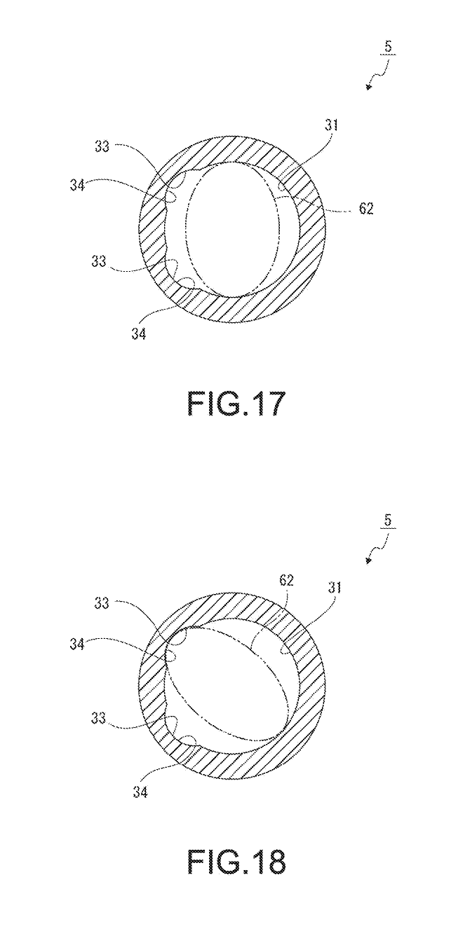

In the state where the index finger 62 (or the middle finger 63 or the ring finger 64) is inserted in the grip portion 50, a ball 62a of the index finger 62 is placed on a portion of the finger placement portion 31, in which the recess portions 33, 33 are not present (see FIG. 17). It is desirable to make the diameter of the grip portion 50 as small as possible in the size corresponding to the thickness of a finger in order to secure the downsizing of the camera accessory 1. The inner diameter of the grip portion 50 has the minimum size in which the thickness of the finger and downsizing are taken into consideration.

The cross-sectional shape of the finger such as the index finger 62 is a substantially oval shape, and the grip portion 50 is downsized as described above. Thus, in the state where the index finger 62 is inserted in the grip portion 50, the inner circumferential surface of the finger placement portion 31 is pushed against surface portions 62b, 62b of the index finger 62 on both sides in the longitudinal direction of the cross-sectional shape thereof, and the surface portions 62b, 62b on both sides are pushed and deformed by the inner circumferential surface of the finger placement portion 31. Therefore, when the index finger 62 is to be pulled out from the grip portion 50 in this state, it is difficult to pull out the index finger 62 from the grip portion 50 in some cases due to a friction force between the surface portions 62b, 62b and the inner circumferential surface of the finger placement portion 31.

In the case where the index finger 62 is difficult to pull out from the grip portion 50 as described above, rotating the index finger 62 with respect to the grip portion 50 enables one of the surface portions 62b, 62b on both sides in the longitudinal direction to be inserted in one recess portion 33 (see FIG. 18). Therefore, the pushed and deformed state of the surface portions 62b, 62b by the inner circumferential surface of the finger placement portion 31 is released, and the index finger 62 can be easily pulled out from the grip portion 50.

As described above, since the recess portion 33 is formed in the inner circumferential surface of the grip portion 50, a part of the finger is inserted in the recess portion 33 when the finger inserted in the grip portion 50 is set in a predetermined orientation, and the finger can be easily pulled out from the grip portion 50.

Further, since the plurality of recess portions 33, 33 are formed apart from each other in the circumferential direction in the grip portion 50, even when the orientation of the finger inserted in the grip portion 50 is changed by rotation in any direction, a part of the finger is inserted in any of the recess portions 33, 33 at a small rotational angle, and the finger can be pulled out from the grip portion 50 easily and quickly.

Note that the example in which the two recess portions 33 are formed has been described above, but the number of recess portions 33 is arbitrary, and one or three or more of recess portions 33 may be employed.

Furthermore, since the recess portion forming surface 34 that forms the recess portion 33 is formed in a curved surface shape that projects toward the central axis S of the fixed member 5, the inner diameter of the grip portion 50 in the recess portion forming surface 34 is gradually increased toward both the end portions in the axial direction, and thus the finger can be more easily pulled out from the grip portion 50.

<Conclusion>

As described above, the camera accessory 1 includes the imaging apparatus attachment portion 40 to/from which the imaging apparatus 100 is attachable/detachable, the control device attachment portion 15 that holds the control apparatus 200, and the grip portion 50 held by the finger.

Therefore, in the state where the imaging apparatus 100 is attached to the imaging apparatus attachment portion 40 and the control apparatus 200 is held by the control device attachment portion 15, the grip portion 50 can be held by the finger, which makes it possible to improve the functionality corresponding to the imaging situation of the imaging apparatus 100.

Further, since the control device attachment portion 15 is rotatable with respect to the imaging apparatus attachment portion 40, the orientation of the control apparatus 200 held by the control device attachment portion 15 with respect to the imaging apparatus 100 attached to the imaging apparatus attachment portion 40 is changed by rotation of the control device attachment portion 15 with respect to the imaging apparatus attachment portion 40, the control apparatus 200 is set in a desired orientation, and the usability of the camera accessory 1 can be improved.

Furthermore, since the control device attachment portion 15 is rotated with respect to the imaging apparatus attachment portion 40 with the grip portion 50 as a fulcrum, the grip portion 50 is a portion held by the finger and also functions as a rotation fulcrum of the control device attachment portion 15 with respect to the imaging apparatus attachment portion 40, it is unnecessary to separately provide a special rotation fulcrum of the control device attachment portion 15 with respect to the imaging apparatus attachment portion 40, and the structure of the camera accessory 1 can be simplified and downsized.

Additionally, since a part of the grip portion 50 and the control device attachment portion 15 are integrally formed and are rotatable with respect to the imaging apparatus attachment portion 40, the control device attachment portion 15 integrally formed with the grip portion 50 is rotated with respect to the imaging apparatus attachment portion 40, and a rotational mechanism can be formed after high strength of the control device attachment portion 15 and the grip portion 50 is secured.

<Others>

While the example in which a part of the grip portion 50 and the control device attachment portion 15 are integrally rotatable with respect to the imaging apparatus attachment portion 40 has been described above, for example, the control device attachment portion 15 may be configured to be rotated with respect to the grip portion 50 and the imaging apparatus attachment portion 40.

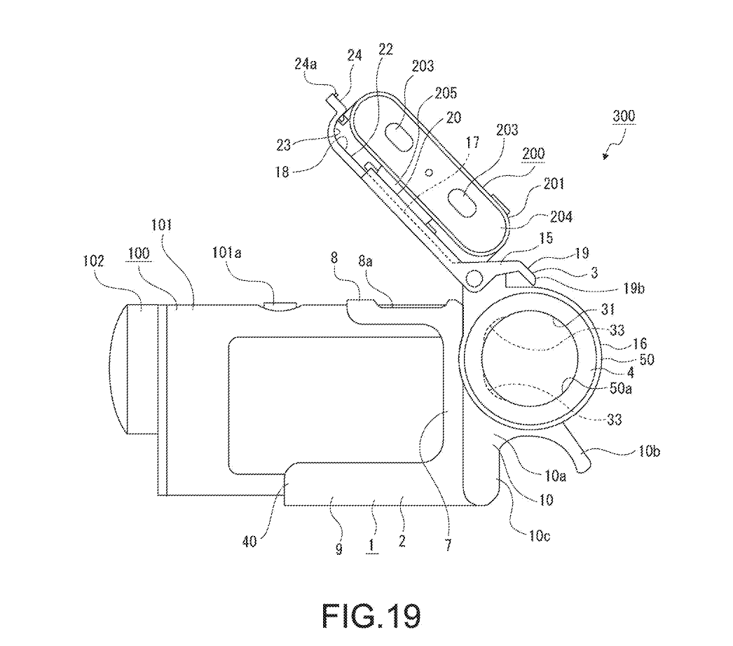

Such a configuration includes, for example, as shown in FIG. 19, a configuration in which the rear end portion of the control device attachment portion 15 is rotatably coupled to the grip portion 50, and the control device attachment portion 15 is rotated with respect to the grip portion 50 and the imaging apparatus attachment portion 40 with a coupling portion of the rear end portion being as a fulcrum.

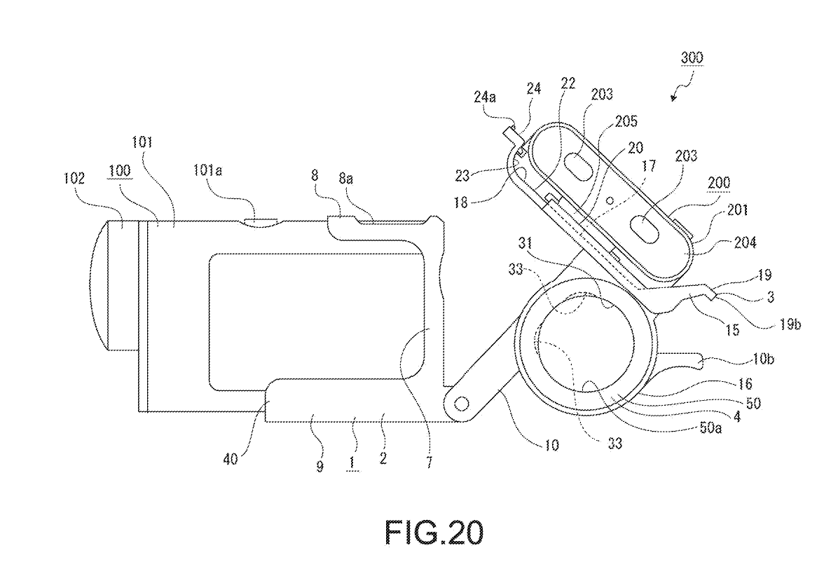

Further, the whole of the grip portion 50 and the control device attachment portion 15 may be configured to be integrally rotatable with respect to the imaging apparatus attachment portion 40 (see FIG. 20). In this case, the support projecting portion 10b is provided to the grip portion 50, and thus it is possible to operate the support projecting portion 10b and rotate the grip portion 50 and the control device attachment portion 15 with respect to the imaging apparatus attachment portion 40.

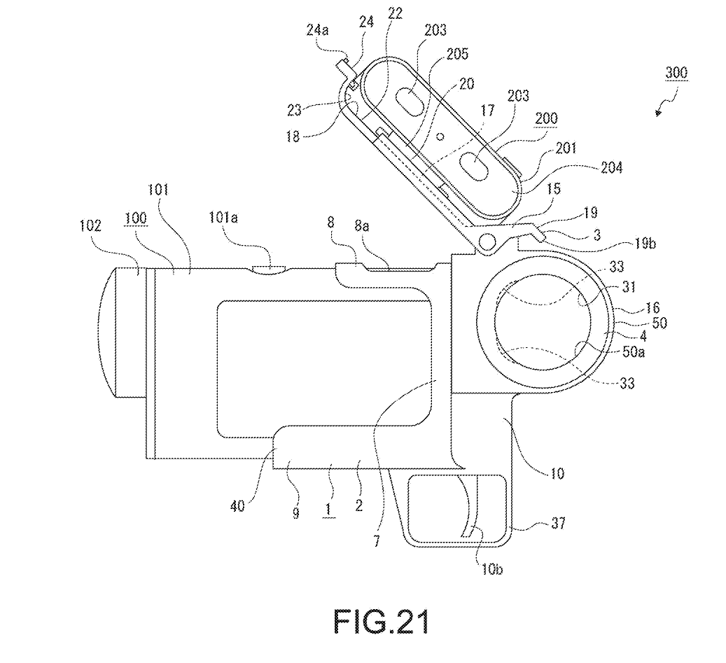

Further, in the configuration in which the support projecting portion 10b is operated, as shown in FIG. 21, it is also possible to provide a frame portion 37 around the support projecting portion 10b, use the support projecting portion 10b as a trigger of a gun, and rotate the control device attachment portion 15 with respect to the imaging apparatus attachment portion 40, the grip portion 40, and the frame portion 37 or integrally rotate the whole of the grip portion 50 and the control device attachment portion 15 with respect to the imaging apparatus attachment portion 40 and the frame portion 37.

In this case, for example, by performing an operation of biasing the grip portion 50 and the control device attachment portion 15 by using a spring or the like in the direction in which the control device attachment portion 15 is rotated toward the second rotation position and of moving rearward the support projecting portion 10b used as a trigger of a gun, it is possible to provide a configuration in which the control device attachment portion 15 is rotated toward the first rotation position against a biasing force.

Further, by performing an operation of biasing the grip portion 50 and the control device attachment portion 15 by using a spring or the like in the direction in which the control device attachment portion 15 is rotated toward the first rotation position, of providing a reversal mechanism that reverses the operation direction of the support projecting portion 10b and the rotational direction of the control device attachment portion 15, and of moving rearward the support projecting portion 10b, it is possible to provide a configuration in which the control device attachment portion 15 is rotated toward the second rotation position against a biasing force.

Furthermore, while the example in which the control apparatus 200 is mounted to and held by the control device attachment portion 15 has been described above, for example, it is also possible to provide a configuration in which the control apparatus 200 is mounted to the control device attachment portion 15 in advance in a non-detachable state or is integrally provided to the control device attachment portion 15.

<Present Technology>

The present technology can have the following configurations.

(1) A camera accessory, including:

an imaging apparatus attachment portion, to/from which an imaging apparatus is attachable/detachable;

a control device attachment portion that holds a control apparatus capable of controlling the imaging apparatus; and

a grip portion that is coupled to the imaging apparatus attachment portion and the control device attachment portion and is held by fingers.

(2) The camera accessory according to (1), in which the grip portion has an annular shape.

(3) The camera accessory according to (2), in which the grip portion has an annular shape except for a part of the grip portion.

(4) The camera accessory according to (2) or (3), in which

an axial direction of the grip portion is set to a direction orthogonal to an optical axis direction of the imaging apparatus attached to the imaging apparatus attachment portion.

(5) The camera accessory according to any one of (2) to (4), in which

the grip portion includes a recess portion formed on an inner circumferential surface of the grip portion.

(6) The camera accessory according to (5), in which

the grip portion includes a plurality of recess portions formed apart from each other in a circumferential direction.

(7) The camera accessory according to (5) or (6), in which

a surface including the recess portion is a recess portion forming surface, and

the recess portion forming surface has a curved shape that projects toward a central portion of the grip portion.

(8) The camera accessory according to any one of (2) to (7), in which

the grip portion includes a finger placement portion on which a finger is placed in a state where the grip portion is held, and

the finger placement portion is formed of a rubber material or a resin material.

(9) The camera accessory according to any one of (1) to (8), in which

the control device attachment portion is rotatable with respect to the imaging apparatus attachment portion.

(10) The camera accessory according to (9), in which

the control device attachment portion is rotatable with respect to the imaging apparatus attachment portion with the grip portion being as a fulcrum.

(11) The camera accessory according to any one of (9) or (10), in which

a part of the grip portion and the control device attachment portion are integrally formed, and

the part of the grip portion and the control device attachment portion are rotatable with respect to the imaging apparatus attachment portion.

(12) The camera accessory according to any one of (9) to (11), in which

the control device attachment portion includes a finger hanging operation portion that is operated when the control device attachment portion is rotated.

(13) The camera accessory according to any one of (1) to (12), in which

the control device attachment portion includes an elastic deformation portion that is elastically deformed when the control apparatus is held, and

the elastic deformation portion includes an engaging portion that is engaged with the control apparatus.

(14) The camera accessory according to any one of (1) to (33), in which

the imaging apparatus attachment portion includes a support projecting portion on which a finger is placed in a state where the grip portion is held.

(15) The camera accessory according to any one of (1) to (14), in which

a part of an outer surface of the imaging apparatus attachment portion is formed as a planar placed surface.

(16) The camera accessory according to (15), in which

the imaging apparatus attachment portion includes a first holding portion and a second holding portion that press the imaging apparatus from opposite sides,

an outer shape of the second holding portion is larger than an outer shape of the first holding portion, and

the second holding portion includes the placed surface.

(17) The camera accessory according to any one of (1) to (16), further including

a locking lever that locks the imaging apparatus in a state where the imaging apparatus is attached to the imaging apparatus attachment portion.

(18) An imaging unit, including:

an imaging apparatus that has an imaging function;

a control apparatus that has a communication function and is capable of controlling the imaging apparatus; and

a camera accessory including

an imaging apparatus attachment portion, to/from which the imaging apparatus is attachable/detachable,

a control device attachment portion that holds the control apparatus, and

a grip portion that is coupled to the imaging apparatus attachment portion and the control device attachment portion and is held by fingers.

### REFERENCE SIGNS LIST

1 camera accessory
6 locking lever
8 first holding portion
9 second holding portion
9b placed surface
10b support projecting portion
15 control device attachment portion
18 elastic deformation portion
19b finger hanging operation portion
23a engaging portion
31 finger placement portion
33 recess portion
34 recess portion forming surface
40 imaging apparatus attachment portion
50 grip portion
100 imaging apparatus
200 control apparatus
300 imaging unit

1. A camera accessory, comprising:
an imaging apparatus attachment portion, to/from which an imaging apparatus is attachable/detachable;
a control device attachment portion that holds a control apparatus capable of controlling the imaging apparatus; and
a grip portion that is coupled to the imaging apparatus attachment portion and the control device attachment portion and is held by fingers.

2. The camera accessory according to claim 1, wherein
the grip portion has an annular shape.

3. The camera accessory according to claim 2, wherein
the grip portion has an annular shape except for a part of the grip portion.

4. The camera accessory according to claim 2, wherein
an axial direction of the grip portion is set to a direction orthogonal to an optical axis direction of the imaging apparatus attached to the imaging apparatus attachment portion.

5. The camera accessory according to claim 2, wherein
the grip portion includes a recess portion formed on an inner circumferential surface of the grip portion.

6. The camera accessory according to claim 5, wherein
the grip portion includes a plurality of recess portions formed apart from each other in a circumferential direction.

7. The camera accessory according to claim 5, wherein
a surface including the recess portion is a recess portion forming surface, and
the recess portion forming surface has a curved shape that projects toward a central portion of the grip portion.

8. The camera accessory according to claim 2, wherein
the grip portion includes a finger placement portion on which a finger is placed in a state where the grip portion is held, and
the finger placement portion is formed of a rubber material or a resin material.

9. The camera accessory according to claim 1, wherein
the control device attachment portion is rotatable with respect to the imaging apparatus attachment portion.

10. The camera accessory according to claim 9, wherein
the control device attachment portion is rotatable with respect to the imaging apparatus attachment portion with the grip portion being as a fulcrum.

11. The camera accessory according to claim 9, wherein
a part of the grip portion and the control device attachment portion are integrally formed, and
the part of the grip portion and the control device attachment portion are rotatable with respect to the imaging apparatus attachment portion.

12. The camera accessory according to claim 9, wherein
the control device attachment portion includes a finger hanging operation portion that is operated when the control device attachment portion is rotated.

13. The camera accessory according to claim 1, wherein
the control device attachment portion includes an elastic deformation portion that is elastically deformed when the control apparatus is held, and
the elastic deformation portion includes an engaging portion that is engaged with the control apparatus.

14. The camera accessory according to claim 1, wherein
the imaging apparatus attachment portion includes a support projecting portion on which a finger is placed in a state where the grip portion is held.

15. The camera accessory according to claim 1, wherein
a part of an outer surface of the imaging apparatus attachment portion is formed as a planar placed surface.

16. The camera accessory according to claim 15, wherein
the imaging apparatus attachment portion includes a first holding portion and a second holding portion that press the imaging apparatus from opposite sides,
an outer shape of the second holding portion is larger than an outer shape of the first holding portion, and
the second holding portion includes the placed surface.

17. The camera accessory according to claim 1, further comprising
a locking lever that locks the imaging apparatus in a state where the imaging apparatus is attached to the imaging apparatus attachment portion.

18. An imaging unit, comprising:
an imaging apparatus that has an imaging function;
a control apparatus that has a communication function and is capable of controlling the imaging apparatus; and
a camera accessory including
an imaging apparatus attachment portion, to/from which the imaging apparatus is attachable/detachable,
a control device attachment portion that holds the control apparatus, and
a grip portion that is coupled to the imaging apparatus attachment portion and the control device attachment portion and is held by fingers.
